(19) United States
(12) Patent Application Publication
(10) Pub. No.: US 2015/0058798 A1
(43) Pub. Date: Feb. 26, 2015

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Manabu Ozawa, Kawasaki-shi (JP)

(21) Appl. No.: 14/463,370

(22) Filed: Aug. 19, 2014

(30) Foreign Application Priority Data
Aug. 21, 2013 (JP) 2013-171516

(51) Int. Cl. G06F 3/0484; G06F 3/0488

(52) U.S. Cl. CPC G06F 3/04845; G06F 3/0488; G06F 3/04883
USPC 715/800

(57) ABSTRACT

An image processing apparatus includes a determination unit configured to determine, if touch input has been performed on a first touch screen provided on a front surface of a display screen, whether a touch position at which the touch input has been performed is within a designated area on a displayed image displayed on the display screen wherein a datum of the designated area is a boundary position of the displayed image, a direction specifying unit configured to specify, if the touch position is a position within the designated area, a one-dimensional scaling direction based on the touch position, and an image processing unit configured to execute scaling processing on the displayed image toward the one-dimensional scaling direction if a user has performed a swipe operation toward the one-dimensional scaling direction, whereby the apparatus can receive a command for the one-dimensional scaling processing through a simple operation matching user's sense.

### BACKGROUND OF THE INVENTION

1. Field of the Invention

The present invention generally relates to image processing and, more particularly, to an image processing apparatus, an image processing method, and a storage medium.

2. Description of the Related Art

Conventionally, an image processing apparatus such as a multifunctional peripheral (MFP) can execute scaling processing to enlarge or reduce an image. In the scaling processing, the user can manually set an enlargement or reduction rate. The image processing apparatus can also execute scaling of an image only in a horizontal direction, i.e., X-direction, or only in a vertical direction, i.e., Y-direction (X/Y independent scaling).

Meanwhile, a touch panel is widely used in recent years, and the image processing apparatus includes a touch panel as a user interface (UI). Development of touch panels has actively been conducted, including development of a multi-touch panel capable of detecting touches at multiple points on a screen, a double-surface touch panel including a touch screen on each of front and rear surfaces of a display unit to enable a user to operate from both surfaces, and the like.

With the development of touch panels, new operation methods have been discussed other than the conventional touch operations. Japanese Patent Application Laid-Open No. 5-100809 discusses an input method by which sliding of a finger on a screen that is called a swipe or flick is detected. Japanese Patent Application Laid-Open No. 5-100809 also discusses an input method by which fingers are placed at two points on a screen, which is called a pinch operation, and a change in the distance between the two points is detected. The swipe or flick is often used to forward or scroll a page. The pinch operation is often used to perform an enlargement or reduction operation.

However, the pinch operation is an operation corresponding to two-dimensional scaling processing toward both X and Y directions. Hence, there have been demands for an operation method for one-dimensional scaling processing such as X/Y independent scaling processing on a touch panel that is different from the pinch operation.

As to a method of inputting a command for X/Y independent scaling processing, a method in which a magnification is directly input is known. Desirably, a command for independent scaling can be input through a simple and intuitive user operation on a touch panel.

### SUMMARY OF THE INVENTION

The present disclosure is directed to providing an arrangement by which a command for one-dimensional scaling processing can be received through a simple and intuitive user operation.

According to an aspect of the present disclosure, an image processing apparatus includes a determination unit configured to determine, if touch input has been performed on a first touch screen provided on a front surface of a display screen, whether a touch position at which the touch input has been performed is within a designated area on a displayed image displayed on the display screen wherein a datum of the designated area is a boundary position of the displayed image, a direction specifying unit configured to specify, if the touch position is a position within the designated area, a one-dimensional scaling direction based on the touch position, and an image processing unit configured to execute scaling processing on the displayed image toward the one-dimensional scaling direction if a user performs a swipe operation toward the one-dimensional scaling direction.

Further features of the present disclosure will become apparent from the following description of exemplary embodiments with reference to the attached drawings.

### BRIEF DESCRIPTION OF THE DRAWINGS

FIG. 1 illustrates a configuration of a MFP.

FIG. 2 illustrates a configuration of an operation unit and an operation control unit.

FIG. 3 is a flowchart illustrating processing executed by the MFP.

FIGS. 4A, 4B, 4C, and 4D illustrate a scaling operation.

FIG. 5, composed of FIGS. 5A and 5B, is a flowchart illustrating edit processing.

FIG. 6 illustrates determination processing.

FIG. 7 illustrates a configuration of an operation unit and an operation control unit.

FIGS. 8A, 8B, and 8C illustrate a scaling operation.

FIG. 9, composed of FIGS. 9A and 9B, is a flowchart illustrating edit processing.

FIGS. 10A, 10B, and 10C illustrate a scaling operation.

### DESCRIPTION OF THE EMBODIMENTS

Various exemplary embodiments, features, and aspects of the disclosure will be described in detail below with reference to the drawings.

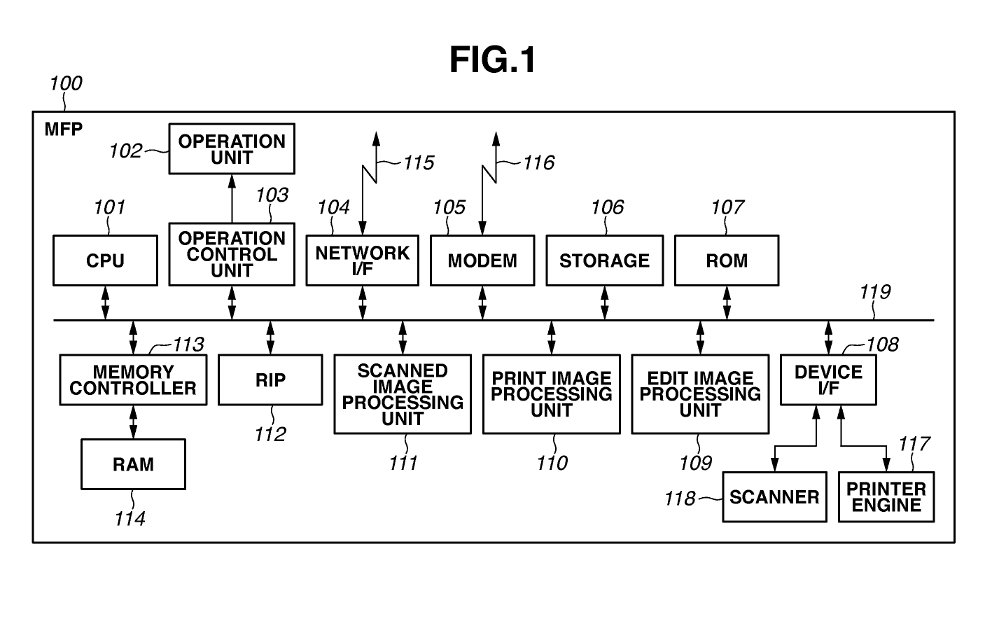

FIG. 1 illustrates a configuration of a MFP (digital multifunctional peripheral) 100 according to a first exemplary embodiment. The MFP 100 is an example of an image processing apparatus. The MFP 100 includes a scanner 118 and a printer engine 117. The scanner 118 is an image input device, and the printer engine 117 is an image output device.

The MFP 100 controls the scanner 118 and the printer engine 117 to read and print output image data. The MFP 100 is connected to a local area network (LAN) 115 and a public telephone line 116 and to control to input and output device information and image data.

The MFP 100 further includes a central processing unit (CPU) 101, an operation unit 102, an operation control unit 103, a network interface (network I/F) 104, a modem 105, a storage 106, a read-only memory (ROM) 107, and a device I/F 108. The MFP 100 further includes an edit image processing unit 109, a print image processing unit 110, a scanned image processing unit 111, a raster image processor (RIP) 112, a memory controller 113, and a random access memory (RAM) 114. As used herein, the term “unit” generally refers to any combination of software, firmware, hardware, or other component that is used to effectuate a purpose.

The CPU 101 is a central processing unit configured to control the MFP 100. The CPU 101 controls a power source of the MFP 100 and determines whether to supply power to a component. The CPU 101 also executes clock control on the MFP 100 to control an operation clock frequency supplied to a component.

The operation unit 102 receives an operation command from a user and displays an operation result. The operation unit 102 includes a display screen and a touch panel superimposed on the display screen. The user can designate via the operation unit 102 various types of image processing to be executed on a preview image displayed on the touch panel.

The operation control unit 103 converts an input signal input via the operation unit 102 into a form that is executable by the MFP 100, and sends it to the CPU 101. The operation control unit 103 also displays image data stored in a drawing buffer on the display screen included in the operation unit 102. The drawing buffer can be included in the RAM 114 or can separately be included in the operation control unit 103.

The network I/F 104 can be realized by, for example, a LAN card or the like. The network I/F 104 is connected to the LAN 115 to input/output device information or image data to/from an external device. The modem 105 is connected to the public telephone line 116 to input/output control information or image data to/from an external device.

The storage 106 is a high-capacity storage device. Typical examples include a hard disk drive and the like. The storage 106 stores system software for various types of processing, input image data, and the like. The ROM 107 is a boot ROM which stores a system boot program. The device I/F 108 is connected to the scanner 118 and the printer engine 117 and executes transfer processing of the image data.

The edit image processing unit 109 executes various types of image processing such as rotation of image data, scaling, color processing, trimming/masking, binarization conversion, multivalued conversion, and blank sheet determination. The print image processing unit 110 executes image processing such as correction according to the printer engine 117 on image data that is to be print output.

The scanned image processing unit 111 executes various types of processing such as correction, processing, and editing on image data read by the scanner 118. The RIP 112 develops page description language (PDL) codes into image data.

The memory controller 113 converts, for example, a memory access command from the CPU 101 or the image processing units into a command that can be interpreted by the RAM 114, and accesses the RAM 114.

The RAM 114 is a system work memory for enabling the CPU 101 to operate. The RAM 114 temporarily stores input image data. The RAM 114 is also an image memory configured to store image data to be edited. The RAM 114 also stores settings data and the like used in print jobs. Examples of parameters stored in the RAM 114 include an enlargement rate, color/monochrome settings information, staple, two-sided print settings, and the like. As another example, the RAM 114 can function as an image drawing buffer for displaying an image on the operation unit 102. The foregoing units are provided on a system bus 119.

The CPU 101 reads a program stored in the ROM 107 or the storage 106 and executes the program to realize the functions and processing of the MFP 100 described below.

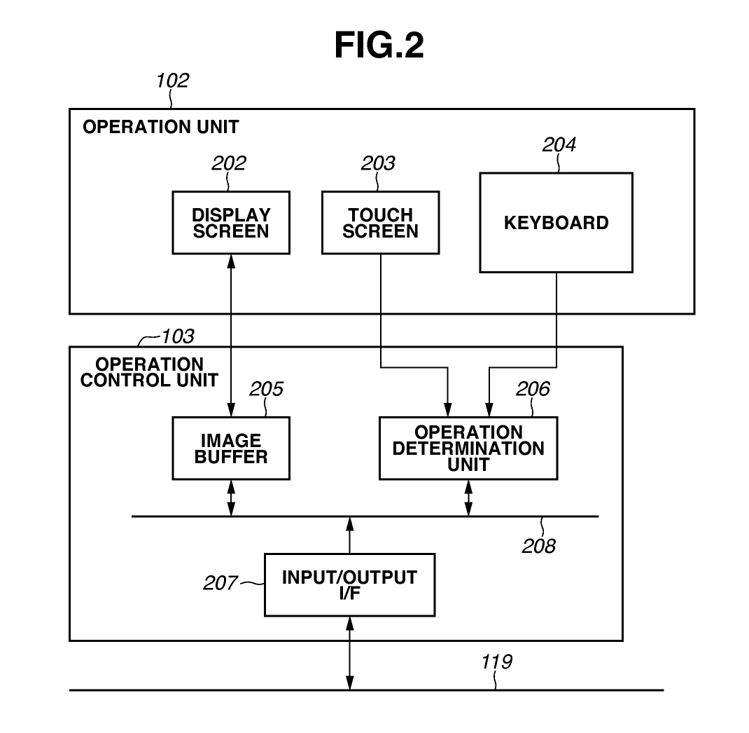

FIG. 2 illustrates a configuration of the operation unit 102 and the operation control unit 103. The operation unit 102 includes a display screen 202 and a touch screen 203. The touch screen 203 is superimposed on a surface of the display screen 202. The display screen 202 displays a UI screen, a preview image, and the like. The touch screen 203 receives input of a touch operation by the user.

The display screen 202 is a display device. Typical examples include a liquid crystal display and the like. The display screen 202 displays a UI for user input of various commands to the MFP 100. The display screen 202 also displays a processing result designated by the user in the form of a preview image or the like.

The touch screen 203 is a device that detects a touch operation when a user performs the touch operation, and outputs input signals to various control units. The touch screen 203 is a device capable of simultaneously detecting touches at a plurality of points. The touch screen 203 is, for example, a projected capacitive multitouch screen or the like. In other words, the touch screen 203 detects two or more designated points and outputs detected signals indicating the two or more designated points thus detected.

The operation unit 102 also includes a keyboard 204. The keyboard 204 receives user inputs of numerical values and the like. As another example, a function that is executable by the keyboard 204 can be a function of a touch UI. In this case, the operation unit 102 can omit to include the keyboard 204.

The operation control unit 103 includes an image buffer 205, an operation determination unit 206, and an input/output I/F 207. The image buffer 205 is a temporary storage device configured to temporarily store content to be displayed on the display screen 202. An image to be displayed on the display screen 202 is text, background image, and the like. The image to be displayed is combined in advance by the CPU 101 or the like. The combined image to be displayed is stored in the image buffer 205 and then sent to the display screen 202 at the drawing timing determined by the CPU 101. Then, the image to be displayed is displayed on the display screen 202. However, as described above, if the RAM 114 is used as an image buffer, the operation control unit 103 can omit to include the image buffer 205.

The operation determination unit 206 converts the content input to the touch screen 203 or the keyboard 204 by a user into a form that can be determined by the CPU 101, and then transfers it to the CPU 101. The operation determination unit 206 according to the present exemplary embodiment associates the type of the input operation, the coordinates at which the input operation has been performed, the time when the input operation was performed, and the like with each other, and stores them as input information. If the operation determination unit 206 receives an input information transmission request from the CPU 101, the operation determination unit 206 sends the input information to the CPU 101.

The input/output I/F 207 connects the operation control unit 103 to an external circuit, and sends signals from the operation control unit 103 to the system bus 119 as appropriate. The input/output I/F 207 also inputs signals from the system bus 119 to the operation control unit 103 as appropriate.

The image buffer 205, the operation determination unit 206, and the input/output I/F 207 are connected to a system bus 208. Each module sends/receives data via the system bus 208 and the input/output I/F 207 to/from modules connected to the system bus 119.

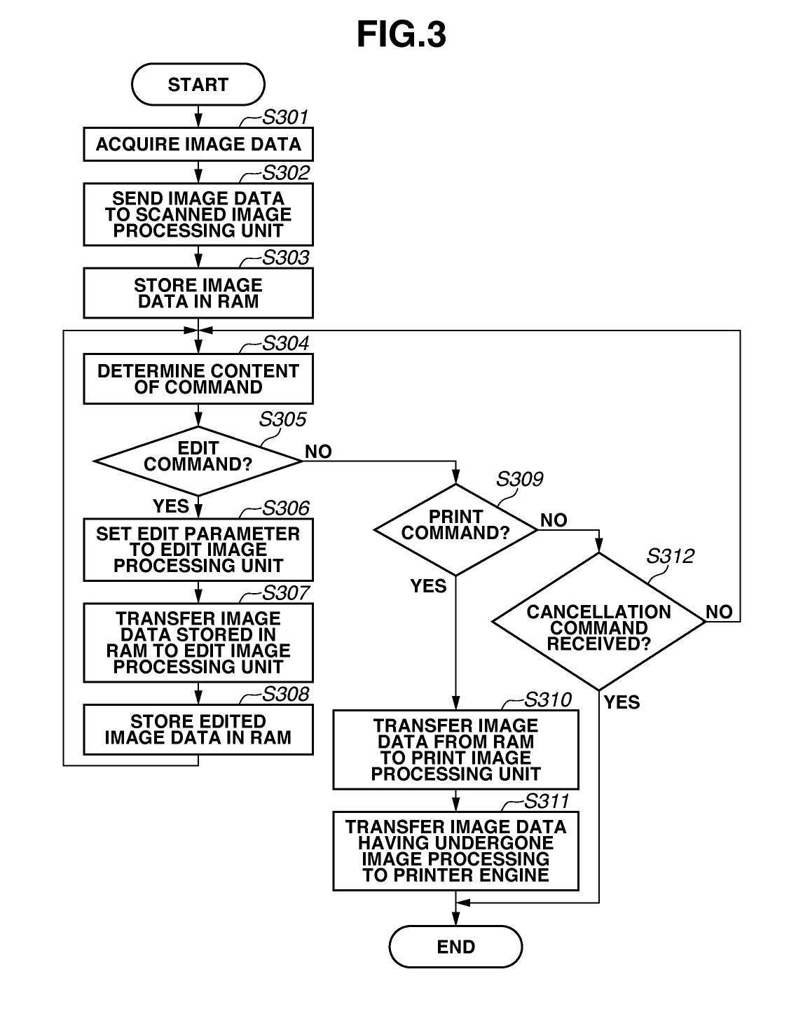

FIG. 3 is a flowchart illustrating processing executed by the MFP 100. In step S301, if a scan-print job is input from the operation unit 102, the CPU 101 acquires image data from the scanner 118.

In step S302, the CPU 101 sends the acquired image data to the scanned image processing unit 111. The scanned image processing unit 111 executes scanner image processing on the image data.

In step S303, the CPU 101 transfers to the RAM 114 the image data having undergone the scanner image processing. Accordingly, the image data is stored in the RAM 114. At this time, the scanned image processing unit 111 generates a preview image from the image data. Then, the CPU 101 transfers the preview image to the operation control unit 103. The operation control unit 103 displays the preview image on the display screen 202.

In step S304, the CPU 101 waits for the input information such as an edit command from the operation unit 102, and if the CPU 101 receives the input information, the CPU 101 determines content of the command indicated by the input information. The content of the command includes an edit command and a print command. The edit command is information that commands editing of image data. The print command is information that commands printing of image data.

In step S305, if the command determined in step S304 is an edit command (YES in step S305), the CPU 101 proceeds to step S306. If the command determined in step S304 is not an edit command (NO in step S305), the CPU 101 proceeds to step S309. In step S306, the CPU 101 sets edit parameters to the edit image processing unit 109 based on the edit command. The edit parameters are, for example, values used in editing an image, such as an enlargement rate and an angle of rotation. In step S307, the CPU 101 transfers the image data stored in the RAM 114 to the edit image processing unit 109. Based on the edit parameters set in step S306, the edit image processing unit 109 executes image processing for editing the image data received in step S307 (image processing).

In step S308, the CPU 101 stores the edited image data in the RAM 114. At this time, the edit image processing unit 109 generates a preview image corresponding to the edited image data. Then, the CPU 101 transfers the preview image to the operation control unit 103. The operation control unit 103 displays on the display screen 202 the preview image corresponding to the edited image data. Then, the CPU 101 proceeds to step S304.

On the other hand, in step S309, if the command determined in step S304 is a print command (YES in step S309), the CPU 101 proceeds to step S310. In step S310, the CPU 101 transfers the image data to be printed out from the RAM 114 to the print image processing unit 110. Then, the print image processing unit 110 executes image processing for printing on the received image data.

In step S311, the CPU 101 transfers to the printer engine 117 the image data having undergone the image processing executed by the print image processing unit 110. The printer engine 117 generates an image based on the image data. Then, the process ends.

On the other hand, in step S309, if the command determined in step S304 is not a print command (NO in step S309), the CPU 101 proceeds to step S312. In step S312, if the operation unit 102 receives a cancellation command (YES in step S312), the CPU 101 cancels the job according to the cancellation command and ends the process. If the operation unit 102 does not receive a cancellation command (NO in step S312), the CPU 101 proceeds to step S304. As described above, if the user inputs an edit command to the MFP 100 according to the present exemplary embodiment, the MFP 100 can display on the display screen 202 an edited preview image according to the edit command.

The edit image processing unit 109 of the MFP 100 according to the present exemplary embodiment can execute image processing such as scaling processing toward X and Y directions (two-dimensional direction) (two-dimensional scaling processing), one-dimensional scaling processing independently toward the X or Y direction (one-dimensional scaling processing), and the like. The X-direction refers to the direction of horizontal sides of a displayed image (horizontal direction). The Y-direction refers to the direction of vertical sides of a displayed image (vertical direction).

Further, the user can input an edit command designating the edit processing to the MFP 100 according to the present exemplary embodiment by operation on the touch screen 203. For example, if the user performs a pinch-in or pinch-out operation on the touch screen 203 in an edit mode, the MFP 100 receives an edit command for the two-dimensional scaling processing and executes the two-dimensional scaling processing.

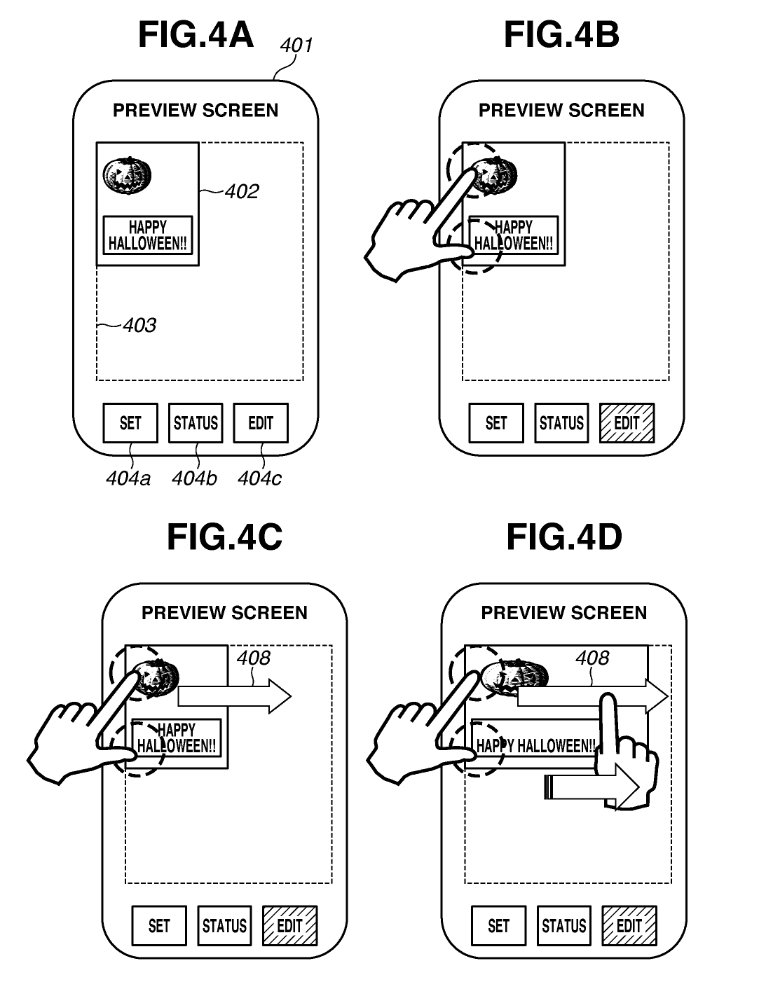

The following describes a scaling operation performed on the touch screen 203 by the user to input an edit command for the one-dimensional scaling processing, with reference to FIGS. 4A to 4D. In the following description, a case is described in which, as illustrated in FIG. 4A, while a displayed image 402 is displayed, the user inputs an edit command for the one-dimensional scaling processing to enlarge the displayed image 402 toward the X-direction.

The display screen 202 illustrated in FIG. 4A displays a preview image 401. The preview image 401 includes the displayed image 402 to be edited, an editable area 403, and various function buttons 404a, 404b, and 404c.

The user can input an edit command by a touch operation, a swipe operation, a flick operation, a pinch-in/pinch-out operation, or the like on the displayed image 402. The result of editing is immediately reflected on the display screen 202 through the processing illustrated in FIG. 3. The user can determine whether to continue or end the editing while looking at the preview image displayed as the editing result.

The editable area 403 is an area that is displayed when the user performs a scaling operation. The editable area 403 shows a positional relationship between an expected print sheet and an image to be printed. In other words, the editable area 403 plays a role as a guide.

The set button 404a is a function button for confirming as a print setting an edit operation performed on the displayed image 402. The status button 404b is a function button for displaying a result of current editing in parameters. The edit button 404c is a function button for switching on/off the edit mode.

FIG. 4B illustrates a first operation performed at the time of giving an edit command for the one-dimensional scaling processing to enlarge a displayed image toward the X-direction. The user first presses the edit button 404c. In response to the pressing, the CPU 101 switches the display mode from a preview mode to the edit mode.

Next, to enlarge the displayed image 402 rightward, the user touches two points within a designated area with the left edge of the displayed image 402 being its datum, as illustrated in FIG. 4B. The minimum number of points to be touched is two. The user can touch more than two points.

The designated area is a preset area with a boundary position (right edge, left edge, upper edge, or lower edge) of the displayed image 402 being its datum. The designated area is stored in, for example, the RAM 114 or the like. The designated area is indicated by relative values with respect to the displayed image 402, e.g., an area up to 50% of the entire length of the horizontal side of the displayed image 402 from the left edge of the displayed image 402, an area up to 25% of the entire length of the horizontal side of the displayed image 402 from the left edge of the displayed image 402, etc.

If the user performs touch input at two or more points, the CPU 101 determines the touch input as a scaling operation corresponding to the scaling processing, and specifies a fixed axis. The fixed axis is a datum axis in the one-dimensional scaling processing. In other words, the position of the fixed axis does not change before and after the one-dimensional scaling processing. If the user performs touch input within the designated area a datum of which is the left edge of the displayed image 402, the CPU 101 specifies the left edge of the displayed image 402 as the fixed axis.

To enlarge the displayed image 402 leftward, the user touches two or more points within the designated area a datum of which is the right edge of the displayed image 402. In this case, the CPU 101 specifies the right edge as the fixed axis.

To enlarge the displayed image 402 downward, the user touches two or more points within the designated area a datum of which is the upper edge of the displayed image 402. In this case, the CPU 101 specifies the upper edge as the fixed axis.

To enlarge the displayed image 402 upward, the user touches two or more points within the designated area a datum of which is the lower edge of the displayed image 402. In this case, the CPU 101 specifies the lower edge as the fixed axis.

If the user performs the touch input illustrated in FIG. 4B, the CPU 101 specifies the scaling direction based on a touch position at which the touch input has been performed. Then, the CPU 101 displays an arrow image 408 indicating the scaling direction, as illustrated in FIG. 4C. The arrow image 408 is an image of a right-pointing arrow indicating the direction of enlargement. The arrow image 408 enables the user to recognize a scalable direction.

While the arrow image 408 illustrated in FIG. 4C is an arrow indicating the direction of enlargement, as another example, the arrow image 408 may be an image of a two-headed arrow indicating both the directions of reduction and enlargement.

The CPU 101 needs to display information that notifies the user of the scaling direction, and the information is not limited to the arrow images. For example, the CPU 101 may display text such as “operable toward the right or left.” Furthermore, for example, the CPU 101 may display an image other than an arrow that can indicate the direction.

Then, as illustrated in FIG. 4D, if the user performs a rightward swipe operation on the displayed image 402, the CPU 101 determines a magnification corresponding to the distance of the scaling direction in the swipe operation. Then, the CPU 101 determines that the command input by the user is an edit command for enlargement processing toward the X-direction at the determined magnification. Then, the CPU 101 controls the enlargement processing to enlarge the displayed image 402 displayed on the display screen 202.

If the user desires leftward enlargement processing, the user performs touch input on the designated area of the right edge to fix it and then performs a leftward swipe operation. In this case, the CPU 101 determines that the command input by the user is an edit command for leftward enlargement processing of the displayed image 402.

If the user desires downward enlargement processing, the user performs touch input on the designated area of the upper edge to fix it and then performs a downward swipe operation. In this case, the CPU 101 determines that the command input by the user is an edit command for downward enlargement processing of the displayed image 402.

If the user desires upward enlargement processing, the user performs touch input on the designated area of the lower edge to fix it and then performs a upward swipe operation. In this case, the CPU 101 determines that the command input by the user is an edit command for upward enlargement processing of the displayed image 402.

As described above, the user performs touch input on the MFP 100 according to the present exemplary embodiment to fix one edge of the displayed image when performing an operation for the scaling processing. Thus, a swipe operation for moving the displayed image 402 toward the right and a scaling operation can be distinguished from each other.

Accordingly, the MFP 100 can receive as a scaling operation an operation that matches the user's sense of extending a displayed image. In other words, the user can intuitively perform the scaling operation.

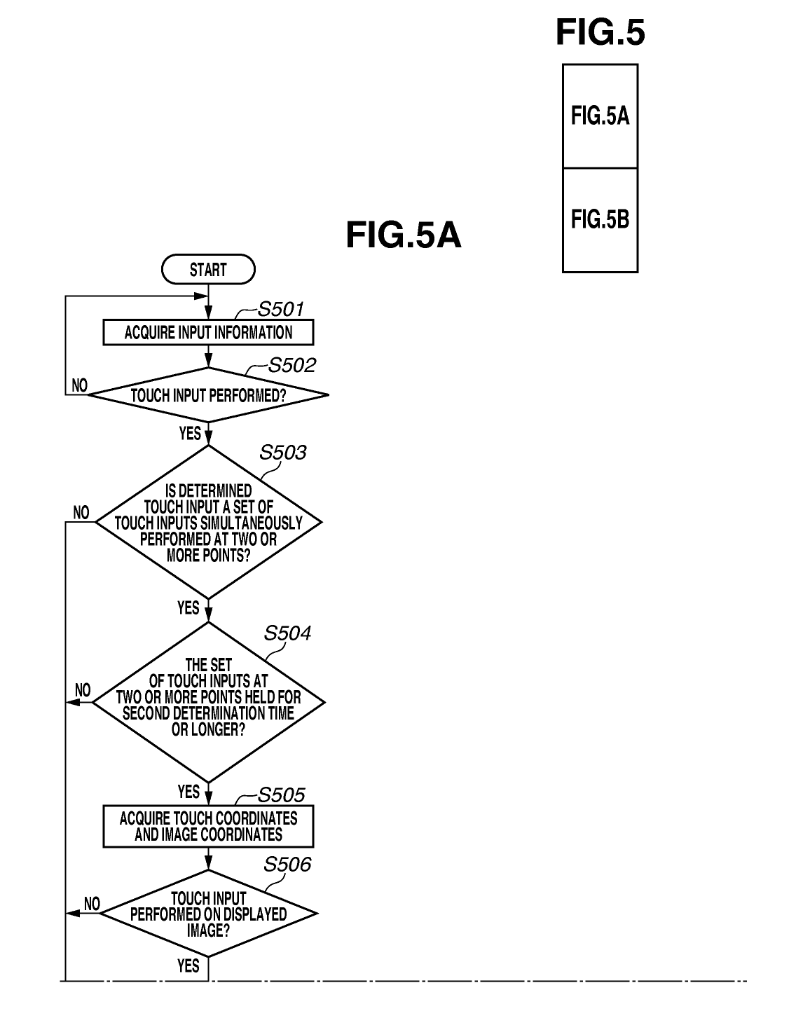

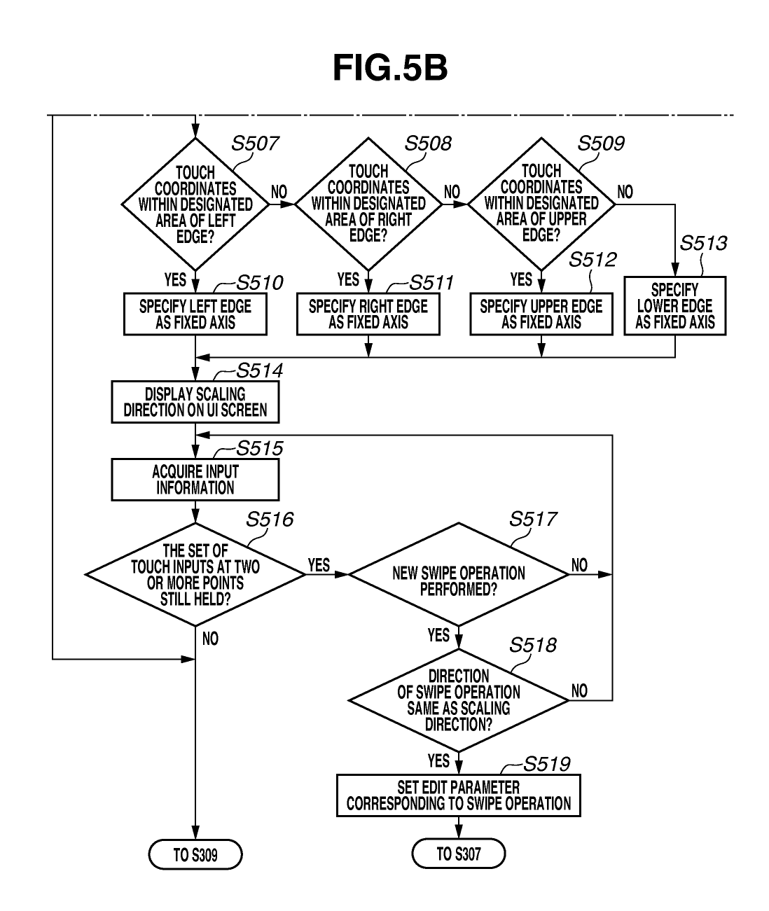

FIG. 5, composed of FIGS. 5A and 5B, is a flowchart illustrating edit processing executed by the MFP 100. The edit processing corresponds to steps S304 to S306 illustrated in FIG. 3. In step S501, the CPU 101 acquires input information from the operation control unit 103. If the user operates the touch screen 203, the operation control unit 103 generates the input information in which information about whether the user performed a touch or a swipe is associated with the coordinates and the time at which the operation was performed. The operation control unit 103 retains the input information for a predetermined time. The CPU 101 periodically accesses the operation control unit 103 to acquire the input information retained by the operation control unit 103.

In step S502, based on the input information, the CPU 101 determines whether the user has performed touch input on the touch screen 203. If the user has not performed touch input (NO in step S502), the CPU 101 proceeds to step S501. If the user has performed touch input (YES in step S502), the CPU 101 proceeds to step S503.

In step S503, based on the input information, the CPU 101 determines whether the touch input determined in step S502 is a set of touch inputs simultaneously performed at two or more points. The CPU 101 determines that the touch input determined in step S502 is a set of touch inputs simultaneously performed at two or more points if the touch inputs at the two or more points are performed within a first determination time.

If the touch input is a set of touch inputs simultaneously performed at two or more points (YES in step S503), the CPU 101 proceeds to step S504. If the touch input is not a set of touch inputs simultaneously performed at two or more points (NO in step S503), the CPU 101 determines that the touch input is not an input of an edit command, and the CPU 101 proceeds to step S309 (in FIG. 3).

In step S504, the CPU 101 determines whether the touch inputs simultaneously performed at the two or more points are held for a second determination time or longer without a change in touch positions of the touch inputs. For example, if the user performs a pinch operation or terminates the touch, the CPU 101 determines that the touch inputs at the two or more points are not held for the second determination time or longer.

If the touch inputs at the two or more points are not held for the second determination time or longer (NO in step S504), the CPU 101 proceeds to step S309. If the touch inputs at the two or more points are held for the second determination time or longer (YES in step S504), the CPU 101 proceeds to step S505.

The first and the second determination times are preset values and are stored in, for example, the RAM 114 or the like.

If the user performs touch input at two or more points, the CPU 101 according to the present exemplary embodiment determines that an edit command for the one-dimensional scaling processing is input, and the CPU 101 executes step S505 and subsequent steps. In other words, the touch input at two or more points is an operation for inputting an edit command for the one-dimensional scaling processing.

The operation for inputting an edit command for the one-dimensional scaling processing is not limited to that in the exemplary embodiments, and can be any operation different from the operations for inputting the two-dimensional scaling processing such as a pinch-in operation and a pinch-out operation. As another example, the CPU 101 may determine that an edit command for the one-dimensional scaling processing is input if the user performs touch input at a single point for a predetermined time or longer.

In step S505, the CPU 101 acquires touch coordinates and image coordinates at which the displayed image 402 is displayed. The image coordinates are stored in a temporary storage area such as the RAM 114, and the CPU 101 acquires the image coordinates from the RAM 114. In step S506, based on the touch coordinates and the image coordinates, the CPU 101 determines whether the user has performed touch input on the displayed image 402.

If the user has performed touch input on the displayed image 402 (YES in step S506), the CPU 101 proceeds to step S507. If the user has not performed touch input on the displayed image 402 (NO in step S506), the CPU 101 proceeds to step S309.

In step S507, the CPU 101 determines whether the touch coordinates are within the designated area of the left edge of the displayed image 402. If the touch coordinates are within the designated area of the left edge of the displayed image 402 (YES in step S507), the CPU 101 proceeds to step S510. If the touch coordinates are not within the designated area of the left edge of the displayed image 402 (NO in step S507), the CPU 101 proceeds to step S508.

In step S508, the CPU 101 determines whether the touch coordinates are within the designated area of the right edge of the displayed image 402. If the touch coordinates are within the designated area of the right edge of the displayed image 402 (YES in step S508), the CPU 101 proceeds to step S511. If the touch coordinates are not within the designated area of the right edge of the displayed image 402 (NO in step S508), the CPU 101 proceeds to step S509.

In step S509, the CPU 101 determines whether the touch coordinates are within the designated area of the upper edge of the displayed image 402. If the touch coordinates are within the designated area of the upper edge of the displayed image 402 (YES in step S509), the CPU 101 proceeds to step S512. If the touch coordinates are not within the designated area of the upper edge of the displayed image 402 (NO in step S509), the CPU 101 proceeds to step S513. In other words, the CPU 101 proceeds to step S513 if the touch coordinates are within the designated area of the lower edge of the displayed image 402. The processes in steps S506, S507, S508, and S509 are examples of determination processing.

In step S510, the CPU 101 specifies the left edge of the displayed image 402 as the fixed axis and then proceeds to step S514. In step S511, the CPU 101 specifies the right edge of the displayed image 402 as the fixed axis and then proceeds to step S514. In step S512, the CPU 101 specifies the upper edge of the displayed image 402 as the fixed axis and then proceeds to step S514. In step S513, the CPU 101 specifies the lower edge of the displayed image 402 as the fixed axis and then proceeds to step S514. The processes in steps S510, S511, S512, and S513 are examples of fixed axis specifying processing.

As described above, the CPU 101 can specify the fixed axis based on the touch positions of the touch inputs at two or more points.

In step S514, based on the fixed axis, i.e., the touch position specified in step S510, S511, S512, or S513, the CPU 101 specifies the scaling direction toward which the scaling operation can be performed (scaling direction specifying processing). Then, the CPU 101 displays the scaling direction on the UI screen (display screen 202) (display processing) and then proceeds to step S515. The arrow image 408 illustrated in FIG. 4C is displayed through the process of step S514.

In step S515, the CPU 101 acquires the input information from the operation control unit 103. In step S516, based on the input information acquired in step S515, the CPU 101 determines whether the user is still holding the touch inputs at the two or more points. If the user is still holding the touch inputs at the two or more points (YES in step S516), the CPU 101 proceeds to step S517. If the user is no longer holding the touch inputs at the two or more points (NO in step S516), the CPU 101 proceeds to step S309.

In step S517, based on the input information, the CPU 101 determines whether the user has performed a new swipe operation other than the touch inputs while holding the touch inputs at the two or more points. The CPU 101 determines that the user has not performed a swipe operation if the user has not performed a new touch operation or if the user has performed touch input but has not shifted to a swipe operation.

If the user has performed a swipe operation (YES in step S517), the CPU 101 proceeds to step S518. If the user has not performed a swipe operation (NO in step S517), the CPU 101 proceeds to step S515.

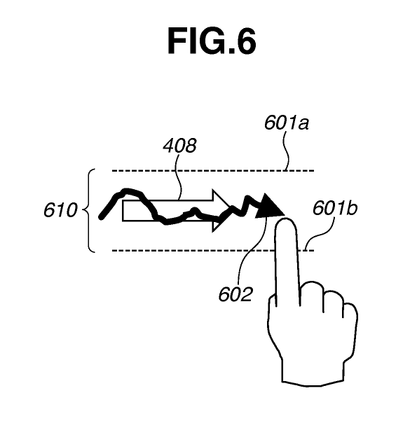

In step S518, the CPU 101 determines whether the direction of the swipe operation is the same as the scaling direction. The determination processing of determining whether the direction of the swipe operation is the same as the scaling direction will be described below with reference to FIG. 6.

If the direction of the swipe operation is the same as the scaling direction (YES in step S518), the CPU 101 proceeds to step S519. In step S519, the CPU 101 generates an edit parameter corresponding to the swipe operation, sets the edit parameter to the edit image processing unit 109, and then proceeds to step S307 (in FIG. 3). On the other hand, if the direction of the swipe operation is not the same as the scaling direction (NO in step S518), the CPU 101 proceeds to step S515.

By the foregoing processing, if the user performs a swipe operation toward the right as illustrated in FIG. 4D, the CPU 101 specifies the left edge, i.e., left side, of the displayed image 402 as the fixed axis based on the set edit parameter, and then enlarges the displayed image 402 to extend the displayed image 402 toward the right. If the user performs a swipe operation toward the left, the CPU 101 reduces the displayed image 402 using the left side as the fixed axis to perform table compression the displayed image 402.

FIG. 6 illustrates the determination processing of step S518. FIG. 6 illustrates a state in which the user performs a swipe operation toward the right as illustrated in FIG. 4D during the state in which the scaling processing for rightward enlargement is executable. In FIG. 6, a trail 602 indicates the trail of the swipe operation performed by the user. As illustrated in FIG. 6, although the user performs a swipe operation toward the horizontal direction, the trail 602 of the swipe operation includes vertical movements.

In view of the foregoing, the MFP 100 according to the present exemplary embodiment, for example, presets to the RAM 114 or the like an input range 610 based on the displayed position of the arrow image 408. When the user performs a swipe operation within the input range 610, the CPU 101 discards displacements along the Y-direction and detects only displacements along the X-direction. This enables the user to input an edit command for the scaling processing without being frustrated.

As another example, guiding lines 601a and 601b indicating the input range 610 may be displayed together with the arrow image 408. This enables the user to perform a swipe operation within the guiding lines 601a and 601b.

As described above, the MFP 100 according to the present exemplary embodiment can receive designation of the fixed axis in the one-dimensional scaling processing through user touch inputs at two or more points. Furthermore, the MFP 100 can receive designation of a magnification corresponding to a swipe operation.

In other words, the MFP 100 can receive a command for the one-dimensional scaling processing through a simple operation that matches the user's sense. Furthermore, the user can command the one-dimensional scaling processing by an intuitive and simple operation.

Further, the scaling operation determined by the MFP 100 according to the present exemplary embodiment as the edit command for the scaling processing is different from a pinch operation. This enables the MFP 100 to determine the edit command for the one-dimensional scaling processing by clearly distinguishing the edit command from a command for the two-dimensional scaling processing.

The scaling operation according to the present exemplary embodiment is also different from a mere swipe operation. This enables the MFP 100 to determine the edit command for the one-dimensional scaling processing by clearly distinguishing the edit command from a command for processing to move an object such as a displayed image.

As a first modification example of the present exemplary embodiment, the CPU 101 may execute processing of at least one module among the edit image processing unit 109, the print image processing unit 110, and the scanned image processing unit 111. In this case, the MFP 100 may omit to include the module to be processed by the CPU 101. For example, the CPU 101 may read image data stored in the RAM 114 in step S307 and executes image processing for editing based on the edit parameter.

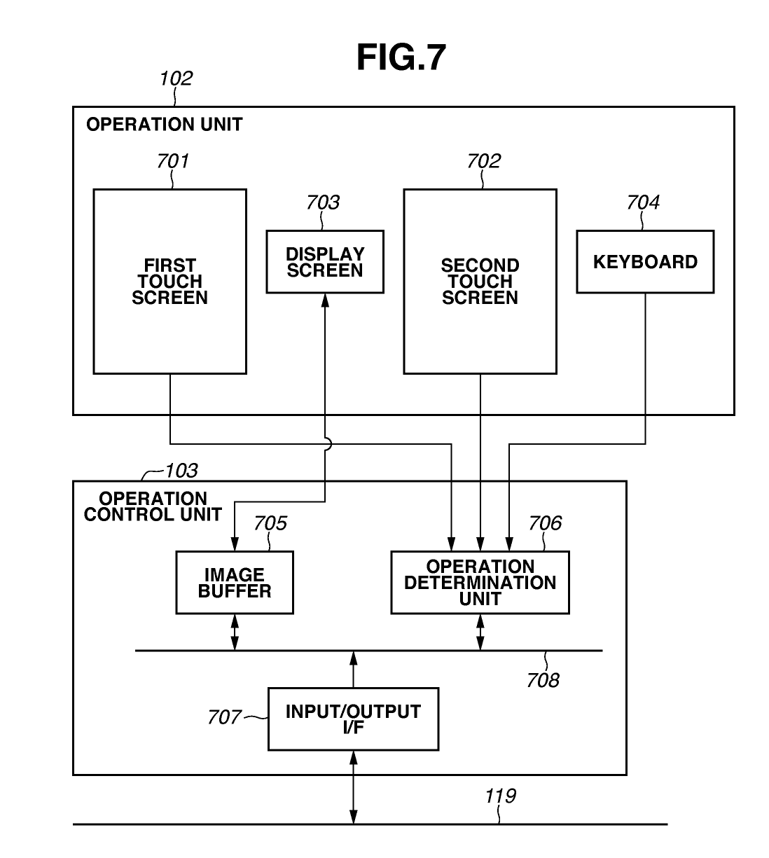

The following describes a MFP 100 according to a second exemplary embodiment. The MFP 100 according to the second exemplary embodiment includes two touch screens. FIG. 7 illustrates a configuration of an operation unit 102 and an operation control unit 103 of the MFP 100 according to the second exemplary embodiment. In the present exemplary embodiment, only the points that are different from the operation unit 102 and the operation control unit 103 according to the first exemplary embodiment (in FIG. 2) will be described.

The operation unit 102 includes a first touch screen 701, a second touch screen 702, a display screen 703, and a keyboard 704. The first touch screen 701 is superimposed on a front surface of the display screen 703. The second touch screen 702 is superimposed on a rear surface of the display screen 703. In other words, when a user operates the MFP 100, the first touch screen 701 is disposed to face the user.

Each of the first touch screen 701 and the second touch screen 702 is a multi-touch screen. Hereinafter, the first touch screen 701 and the second touch screen 702 are sometimes referred to as touch screens 701 and 702, respectively.

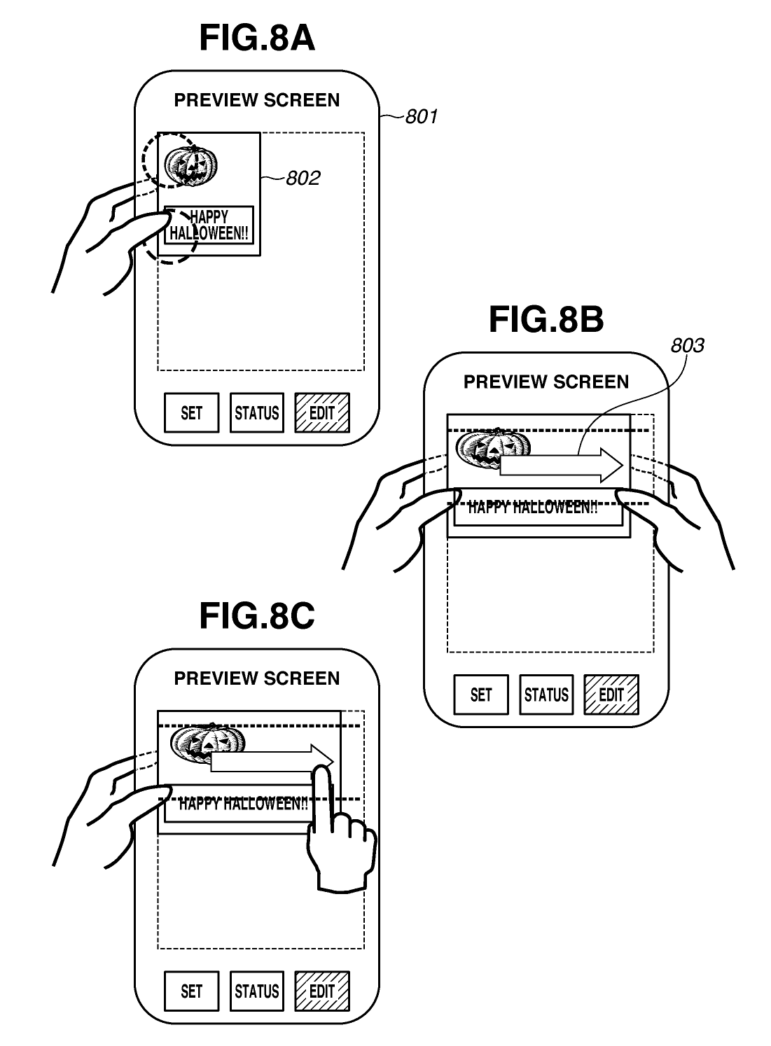

FIGS. 8A to 8C illustrate a scaling operation performed by the user on the touch screens 701 and 702 according to the second exemplary embodiment. The present exemplary embodiment will describe a case in which while a displayed image 802 is displayed as illustrated in FIG. 8A, the user inputs an edit command for the scaling processing to enlarge the displayed image 802 toward the X-direction.

FIG. 8A illustrates the first operation the user performs when inputting an edit command for the scaling processing toward the X-direction. The user touches the displayed image 802 to be scaled on the first touch screen 701 and also touches the displayed image 802 on the second touch screen 702. On the second touch screen 702, the user touches the rear surface of the displayed image 802. In this way, the user can designate the fixed axis by grabbing the displayed image 802 on the touch screens 701 and 702.

The MFP 100 according to the present exemplary embodiment determines that the user has input an edit command for the one-dimensional scaling processing if the user has performed touch input at one or more points on the displayed image 802 on each of the touch screens 701 and 702. In this way, the user can designate the fixed axis through an intuitive operation.

If the user performs touch input as illustrated in FIG. 8A, the CPU 101 determines the scaling direction based on the touch position. Then, as illustrated in FIG. 8B, the CPU 101 displays an arrow image 803 indicating the scaling direction. The arrow image 803 is an image of a right-pointing arrow indicating the direction of enlargement. The arrow image 803 enables the user to recognize a scalable direction.

Then, as illustrated in FIG. 8B, the user grabs the displayed image 802 the touch screens 701 and 702 and performs a swipe operation along the scaling direction while keeping grabbing the displayed image 802. In response to the operation, the CPU 101 of the MFP 100 can determine that the user has input an edit command for the one-dimensional scaling processing to enlarge the displayed image 802 toward the X-direction at a magnification corresponding to the distance of the swipe operation along the scaling direction.

As another example, the CPU 101 may determine that the user has input an edit command for the one-dimensional scaling processing to enlarge the displayed image 802 toward the X-direction if the user performs a swipe operation only on the first touch screen 701 as illustrated in FIG. 8C.

The designated areas for designating the fixed axis of the displayed image 802 are the same as the designated areas according to the first exemplary embodiment. Specifically, the designated areas are the four areas whose datums are the right, the left, the lower, and the upper edges, respectively.

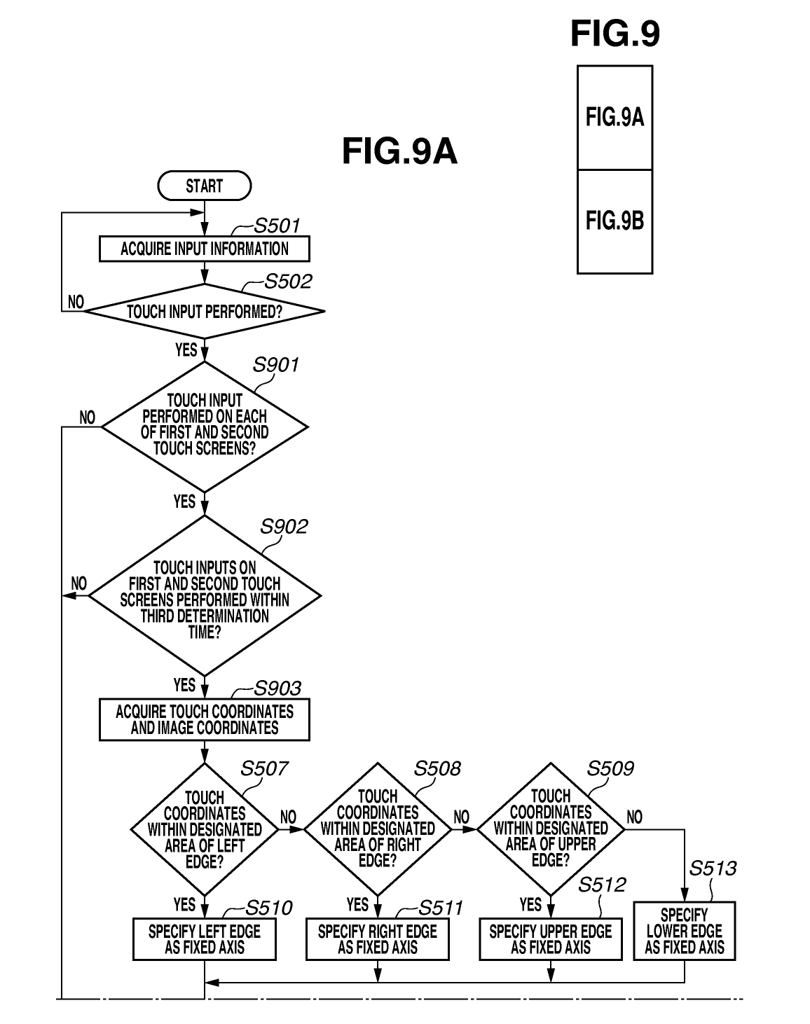

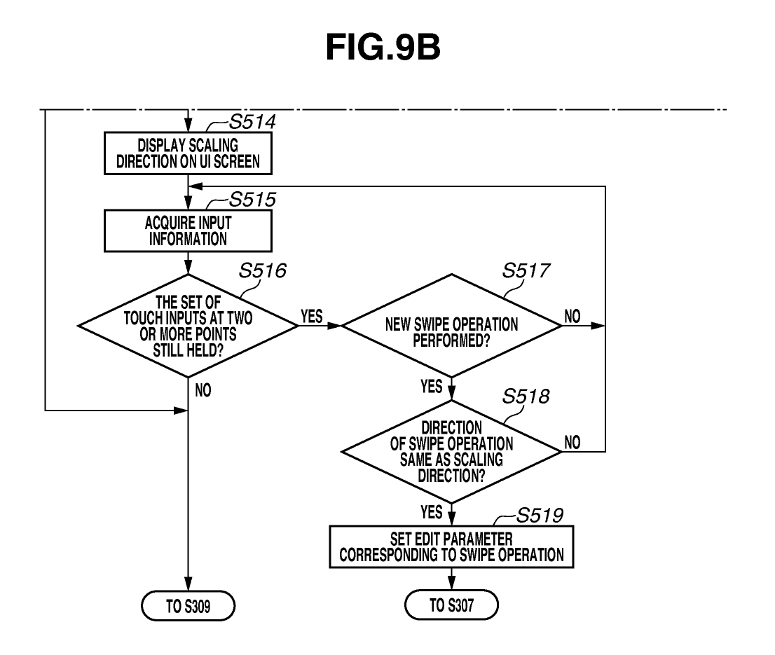

FIG. 9, composed of FIGS. 9A and 9B, is a flowchart illustrating edit processing executed by the MFP 100 according to the second exemplary embodiment. In the present exemplary embodiment, processes that are different from those in the edit processing executed by the MFP 100 according to the first exemplary embodiment (in FIG. 5) will be described. Processes that are the same as those in the edit processing according to the first exemplary embodiment (in FIG. 5) are given the same reference numerals.

In step S502, if the user performs touch input, the CPU 101 proceeds to step S901. In step S901, based on the input information, the CPU 101 determines whether the user has performed the touch input on each of the first touch screen 701 and the second touch screen 702.

If the user has performed the touch input on each of the two touch screens 701 and 702 (YES in step S901), the CPU 101 proceeds to step S902. If the user has not performed the touch input on each of the two touch screens 701 and 702 (NO in step S901), the CPU 101 proceeds to step S309 (in FIG. 3).

In step S902, based on the input information, the CPU 101 determines whether the touch inputs on the two touch screens 701 and 702 are performed simultaneously. The CPU 101 determines that the touch inputs on the two touch screens 701 and 702 are performed simultaneously if the touch inputs on the two touch screens 701 and 702 are performed within a third determination time. The third determination time is stored in advance in the RAM 114 or the like.

If the touch inputs on the two touch screens 701 and 702 are performed within the third determination time (YES in step S902), the CPU 101 proceeds to step S903. If the touch inputs on the two touch screens 701 and 702 are not performed within the third determination time (NO in step S902), the CPU 101 proceeds to step S309.

In step S903, the CPU 101 acquires the touch coordinates of each of the touch inputs on the two touch screens 701 and 702 and the image coordinates at which the displayed image 802 is displayed. Then, the CPU 101 associates the touch coordinates with each other such that facing positions of the two touch screens 701 and 702 have the same coordinates. For example, the CPU 101 can convert the touch coordinates on one of the touch screens 701 and 702 into the touch coordinates on the other one of the touch screens 701 and 702. Following the processing in step S903, the CPU 101 proceeds to step S507.

As described above, the MFP 100 according to the second exemplary embodiment enables the user to designate the fixed axis for the one-dimensional scaling processing through touch input corresponding to an operation of grabbing a displayed image on the two surfaces, the front and the rear surfaces, of the display screen 202.

In other words, the MFP 100 can receive a command for the one-dimensional scaling processing through a simple operation that matches user's sense. Further, the user can input a command for the one-dimensional scaling processing through an intuitive and simple operation.

Other configurations and processing of the MFP 100 according to the second exemplary embodiment are the same as those of the first exemplary embodiment.

The following describes a MFP 100 according to a third exemplary embodiment. In a case in which a displayed image to be subjected to the scaling processing includes a plurality of objects, the MFP 100 according to the third exemplary embodiment can execute the one-dimensional scaling processing on an individual object. The term “object” used herein refers to, for example, an individual element included in a displayed image such as an image or a text.

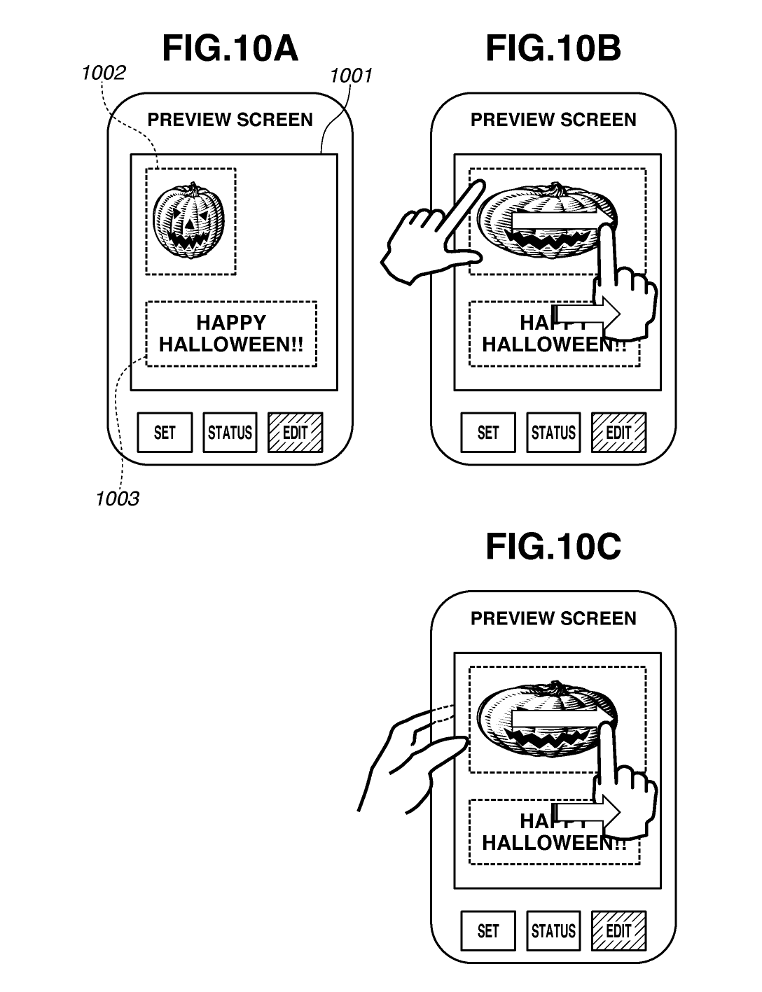

FIGS. 10A to 10C illustrate a scaling operation for inputting an edit command for the one-dimensional scaling processing on an individual object. In the present exemplary embodiment, a case in which an edit command for the scaling processing to enlarge an object 1002 toward the X-direction is input will be described.

FIG. 10A illustrates an example of a displayed image displayed on a preview screen. This displayed image 1001 includes an image attribute object 1002 and a text attribute object 1003.

In general, an image includes a text attribute object or an image attribute object located at predetermined coordinates. Such an image format is called a vector format and is widely used in image processing apparatuses such as the MFP 100. The displayed image 1001 illustrated in FIG. 10A is a vector-based image.

As illustrated in FIG. 10B, the user performs touch input on a designated area of the left edge of the object 1002. The CPU 101 of the MFP 100 specifies the fixed axis of the object 1002 according to the user operation. Then, if the user performs a swipe operation toward the right or the left on the object 1002, the CPU 101 executes the one-dimensional scaling processing on the object 1002 according to the user operation. In the example illustrated in FIG. 10B, the user performs enlargement processing toward the X-direction.

FIG. 10C illustrates a scaling operation executed by the MFP 100 including two touch screens such as the MFP 100 according to the second exemplary embodiment. In this case, if the user performs touch input to grab the object 1002 from both the front and the rear surface sides of the display screen 202, the CPU 101 specifies the fixed axis of the object 1002. In this case, the user performs a swipe operation only on the first touch screen 701. As another example, the user may perform a swipe operation on both of the two touch screens 701 and 702 as illustrated in FIG. 8B.

As described above, the MFP 100 according to the third exemplary embodiment can receive designation of the fixed axis for the one-dimensional scaling processing for each object through user touch input. Further, the MFP 100 can receive designation of a scaling rate according to a swipe operation at which the one-dimensional scaling processing is to be executed on an object.

In other words, the MFP 100 can receive a command for the one-dimensional scaling processing for each object through a simple operation that matches user's sense. Further, the user can input a command for the one-dimensional scaling processing for each object through an intuitive and simple operation.

Exemplary embodiments of the present disclosure can also be realized by execution of the following processing. Specifically, software (program) that realizes the functions of the exemplary embodiments described above is supplied to a system or an apparatus via a network or various storage media. Then, a computer (or CPU, micro processing unit (MPU), or the like) of the system or the apparatus reads and executes the program.

According to each of the exemplary embodiments described above, a command for one-dimensional the scaling processing can be received through a simple operation that matches user's sense.

While the foregoing describes the exemplary embodiments of the present disclosure in detail, it is to be understood that the disclosure is not limited to the specific exemplary embodiments and can be modified or altered in various ways within the spirit of the disclosure set forth in the following appended claims.

For example, while the present exemplary embodiments have been described using the MFPs as examples of the image processing apparatus, any image processing apparatus can be employed that includes a multi-touch panel and is configured to execute image processing.

According to the exemplary embodiments of the present disclosure, a command for the one-dimensional scaling processing can be received through a simple operation that matches user's sense.

Embodiments of the present disclosure can also be realized by a computer of a system or apparatus that reads out and executes computer executable instructions recorded on a storage medium (e.g., a non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2013-171516 filed Aug. 21, 2013, which is hereby incorporated by reference herein in its entirety.

What is claimed is:

1. An image processing apparatus comprising:
a determination unit configured to determine, if touch input has been performed on a first touch screen provided on a front surface of a display screen, whether a touch position at which the touch input has been performed is within a designated area on a displayed image displayed on the display screen wherein a datum of the designated area is a boundary position of the displayed image;
a direction specifying unit configured to specify, if the touch position is a position within the designated area, a one-dimensional scaling direction based on the touch position; and
an image processing unit configured to execute scaling processing on the displayed image toward the one-dimensional scaling direction if a user has performed a swipe operation toward the one-dimensional scaling direction.

2. The image processing apparatus according to claim 1, further comprising a display unit configured to display on the display screen the one-dimensional scaling direction specified by the direction specifying unit.

3. The image processing apparatus according to claim 1, further comprising a fixed axis specifying unit configured to specify a fixed axis based on the touch position if the touch position is a position within the designated area,
wherein the image processing unit executes the scaling processing on the displayed image toward the one-dimensional scaling direction by use of the fixed axis as a datum.

4. The image processing apparatus according to claim 1, wherein the direction specifying unit specifies a horizontal direction or a vertical direction of the displayed image as the one-dimensional scaling direction.

5. The image processing apparatus according to claim 1, wherein if the displayed image includes a plurality of objects and the touch input has been performed on the plurality of objects, the determination unit determines whether the touch position is within the designated area wherein a datum of the designated area is a boundary position of the plurality of objects, and
wherein the image processing unit executes the scaling processing on the plurality of objects toward the one-dimensional scaling direction.

6. The image processing apparatus according to claim 1, wherein if touch inputs have been performed at two or more points on the first touch screen, the determination unit determines whether touch positions at which the touch inputs have been performed are within the designated area.

7. The image processing apparatus according to claim 1, wherein if the touch input has been performed at one or more points on each of the first touch screen and a second touch screen provided on a rear surface of the display screen, the determination unit determines whether the touch position is within the designated area.

8. An image processing method that is executed by an image processing apparatus, the method comprising:
determining, if touch input has been performed on a first touch screen provided on a front surface of a display screen, whether a touch position at which the touch input has been performed is within a designated area on a displayed image displayed on the display screen wherein a datum of the designated area is a boundary position of the displayed image;
specifying, if the touch position is a position within the designated area, a one-dimensional scaling direction based on the touch position; and
executing scaling processing on the displayed image toward the one-dimensional scaling direction if a user has performed a swipe operation toward the one-dimensional scaling direction.

9. A storage medium storing a program for causing a computer to function as:
a determination unit configured to determine, if touch input has been performed on a first touch screen provided on a front surface of a display screen, whether a touch position at which the touch input has been performed is within a designated area on a displayed image displayed on the display screen wherein a datum of the designated area is a boundary position of the displayed image;
a direction specifying unit configured to specify, if the touch position is a position within the designated area, a one-dimensional scaling direction based on the touch position;
a display unit configured to display on the display screen the one-dimensional scaling direction specified by the direction specifying unit; and
an image processing unit configured to execute scaling processing on the displayed image toward the one-dimensional scaling direction if a user has performed a swipe operation toward the one-dimensional scaling direction.
